(19) United States
(12) Patent Application Publication
(10) Pub. No.: US 2008/0057887 A1
(43) Pub. Date: Mar. 6, 2008

(54) Method for Communicating Meta Data

(75) Inventors: Brian J. Tucker, Mesa, AZ (US); Chandan Pitta, Phoenix, AZ (US); Shawn T. Rutledge, Phoenix, AZ (US)

Correspondence Address: Motorola, Inc.;Law Department, 1303 East Algonquin Road, 3rd Floor, Schaumburg, IL, 60196, US

(73) Assignee: General Instrument Corporation, Horsham, PA (US)

(21) Appl. No.: 11/468,649

(22) Filed: Aug. 30, 2006

(51) Int. Cl. H04B 1/18; H04B 7/00; H04B 1/06

(52) U.S. Cl. 455/151.2; 455/352; 455/41.2

(57) ABSTRACT

In a method for communicating meta data between a wireless content source and a sink device, vendor-specific pass-through packets of an Audio/Visual Remote Control Profile (AVRCP) header are utilized to communicate the meta data from the wireless content source to the sink device.

### BACKGROUND

Recently, greater attention has been paid to short-distance wireless communication technologies because of their benefits in enabling communications between terminals and peripheral devices. One such technology, Bluetooth®, which is operated and managed by the Bluetooth Special Interest Group (SIG), has been found to be applicable in a variety of industries.

Generally speaking, Bluetooth® is a relatively short distance wireless communication technique that enables communications between Bluetooth® enabled devices through a relatively secure, low-cost, and globally available short range radio frequency. As such, the Bluetooth® technique is currently used to wirelessly interconnect a large number of mobile user devices together in a relatively easy and inexpensive manner. In addition, a technical specification for the Bluetooth® technique has been standardized by the Bluetooth® SIG. Consequently, devices manufactured by different companies are generally compatible with each other when the devices conform to the Bluetooth® technical specification.

The Bluetooth® technical specification is divided into a core and a number of profiles. The core defines the base of the wireless connection provided by the Bluetooth® technique, while the profiles are collections of the technical requirements specified for each application to guarantee the mutual connectivity between the devices. Some examples of Bluetooth® profiles include an Advanced Audio Distribution Profile (hereinafter “A2DP”), a Video Distribution Profile (hereinafter “VDP), and an Audio/Video Remote Control Profile (hereinafter “AVRCP”).

The A2DP functions to connect an audio stream from a source, such as, a portable media player or a stereo, to a sink, such as, a headset or a car radio, to permit streaming reproduction of audio data. The VDP functions to transport a video stream from a source, such as, a portable media player, to a sink, such as, a television, to permit reproduction of video data on the sink. The AVRCP functions to remotely control the source and is often used in concert with the A2DP or the VDP. For instance, the AVRCP typically functions to enable users to remotely control the source through operations performed on the sink.

The current AVRCP profile, however, only provides for simple command oriented messages, such as play, pause, forward and backward, to be communicated between the sink and the source and is therefore relatively limited.

It would therefore be beneficial to enable data, in addition to the simple command oriented messages, to be communicated between the source and the sink to therefore enhance a user's entertainment experience.

### SUMMARY

A method for communicating meta data is disclosed in which vendor-specific pass-through packets of an Audio/Visual Remote Control Profile (AVRCP) header are used to communicate the meta data from a wireless content source to a sink device.

Also disclosed is a wireless device for communicating meta data with a sink device. The wireless device includes a protocol stack configured to enable wireless communications with at least one sink device having a compatible protocol stack. A portion of the protocol stack contains a data structure having multiple bytes of data for remotely controlling at least one of an audio and a video functionality, and wherein the first byte of data in the data structure includes meta data identifying content being at least one of transmitted from and received by the wireless device.

Further disclosed is a sink device for wirelessly communicating with a source device. The sink device includes a protocol stack configured to enable wireless communications with the source device. A portion of the protocol stack is configured to receive a data structure having multiple bytes of data for remotely controlling at least one of an audio and a video functionality, and the first byte of data in the data structure includes meta data identifying content being at least one of transmitted from and received by the sink device.

Further disclosed is a computer-readable data structure, encoded on a computer readable medium, for communicating meta data. The data structure includes a plurality of profiles, at least one of the profiles including a data profile for remote control of at least one of an audio and a video functionality, the at least one data profile for remote control including a field of multiple bytes of data, wherein the first byte of the field includes meta data identifying content being transmitted in accordance with the at least one data profile.

Still further disclosed is a computer readable storage medium on which is embedded one or more computer programs. The one or more computer programs implement a method for communicating meta data between a wireless content source and a sink device. The one or more computer programs include a set of instructions for utilizing vendor-specific pass-through packets of an Audio/Visual Remote Control Profile (AVRCP) header to communicate the meta data between the wireless content source and the sink device.

Information pertaining to the content being wirelessly transmitted between a source device and a sink device may be communicated in a relatively simple manner over existing communication protocols through implementation of the systems and methods described herein. As such, information pertaining to, for instance, song title, song artist, song category, movie title, etc., may be transmitted from the source device to the sink device, such that this information may be displayed to a user on an output device, through the existing communication protocols.

### BRIEF DESCRIPTION OF THE DRAWINGS

Embodiments are illustrated by way of example and not limited in the following figure(s), in which like numerals indicate like elements, in which:

FIG. 1 illustrates a block diagram of a wireless communication system, according to an embodiment;

FIG. 2 illustrates a schematic illustration of the AVRCP profile stack protocol model, according to an embodiment;

FIG. 3 illustrates an AVRCP protocol table, according an embodiment;

FIG. 4 illustrates an element ID definitions table, according to an embodiment;

FIG. 5 illustrates a bit correlation table, according to an embodiment;

FIG. 6 illustrates a method for sending meta data between components of a wireless communication system, according to an embodiment; and

FIG. 7 illustrates a computer system that may be used for components of the wireless communication system depicted in FIG. 1, according to an embodiment.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In other instances, well known methods and structures have not been described in detail so as not to unnecessarily obscure the embodiments.

Disclosed herein is a method for communicating meta data between a source device and a sink device. For instance, meta data may be communicated between a source device and a sink device using the vendor dependent command of the Bluetooth® Audio/Visual Remote Control Profile (hereinafter “AVRCP”) along with an AVRCP Vendor Unique Protocol as described in greater detail herein below. More particularly, the meta data may be communicated through AVRCP vendor-specific pass-through packets to, for instance, thereby leverage upon existing communications protocols.

The meta data may be used to enable transmission of, for instance, a song title, a song artist, a song category, a movie title, etc., over a relatively short range wireless network of devices.

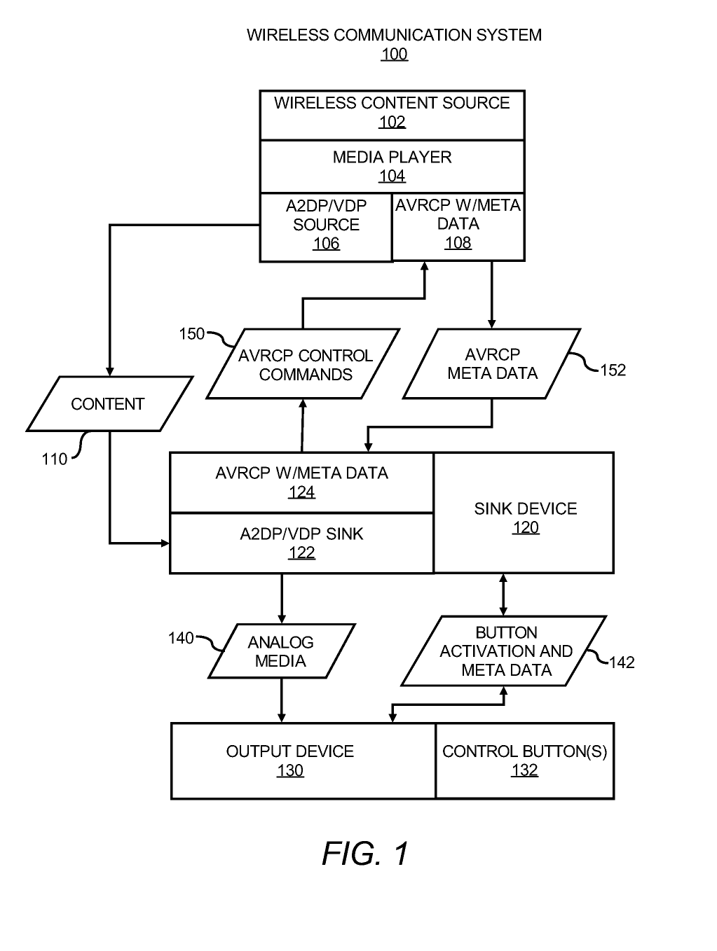

With reference first to FIG. 1, there is shown a block diagram of a wireless communication system 100, according to an example. It should be understood that the following description of the wireless communication system 100 is but one manner of a variety of different manners in which such a wireless communication system 100 may be configured and operated. In addition, it should be understood that the wireless communication system 100 may include additional components and that some of the components described may be removed and/or modified without departing from a scope of the wireless communication system 100.

The wireless communication system 100 is depicted as including a source device, shown as a wireless content source 102. The wireless content source 102 may comprise, for instance, a cellular telephone, a personal digital assistant, a personal computer, an MP3 player, and the like. In addition, the wireless content source 102 is depicted as including a media player 104, which is configured to play content, for instance, media, such as, audio, video, text; multimedia that includes two or more of audio, video and text; or other types of data. Examples of content include, but are not limited to, media files, such as MP3 files, other types of audio files, video files, textual music play lists, and other types of files.

The wireless content source 102 conforms to the Bluetooth® technical specification and thus induces a protocol stack configured to enable wireless communications with one or more sink devices 120, which also conform to the Bluetooth® technical specification. A single sink device 120 is depicted in FIG. 1 for purposes of illustration and not of limitation. The sink device 120 also includes a protocol stack configured to enable wireless communications with at least one wireless content source 102.

The sink device 120 is depicted as comprising an adapter configured to facilitate information transfer between the wireless content source 102 and an output device 130. The output device 130 may comprise, for instance, a car stereo, a headset, speakers, a monitor, etc. In one example, the sink device 120 may comprise a component separate from the output device 130. In this example, the sink device 120 may comprise an adapter configured for use with output devices 130 made by a number of different manufacturers, such as a substantially universal adapter. In another example, the sink device 120 may comprise a component integral with the output device 130. In this example, the sink device 120 and the output device 130 may be manufactured, packaged, sold, etc., as a single unit.

In any regard, the sink device 120 is configured to receive information in the form of content 110 and meta data 152, from the wireless content source 102. More particularly, the wireless content source 102 includes the A2DPVDP source 106 protocol stacks of the Bluetooth® technical specifications to transmit content 110 to the sink device 120. In addition, the sink device 120 includes the A2DPVDP sink 122 protocol stacks of the Bluetooth® technical specifications to receive the content 110 and to forward the content 110 in the form of analog media 140 to the output device 130. The output device 130 may output the analog media 140 in audible, visible or both, formats, depending upon the media type and the output device 130 configuration. Various manners in which the meta data 152 is transmitted from the wireless content source 102 to the sink device 120 are discussed herein below.

The sink device 120 is further configured to communicate AVRCP commands 150 to the wireless content source 102. The AVRCP control commands may include standard as well as AVRCP meta data commands. The AVRCP control commands 150 may originate, for instance, from the output device 130 through activation of one or more control buttons 132. More particularly, activation of the button(s) 132 and, in certain instances, the meta data associated with the activation(s) 142, may be communicated from the output device 130 to the sink device 120.

The sink device 120 follows the AVRCP functions 124 of the Bluetooth® technical specifications to send the standard AVRCP control commands 150. The AVRCP functions 124 have been enhanced as described in greater detail herein below to also enable AVRCP meta data commands to be transmitted to the wireless content source 102, while following the AVRCP functions 124. In addition, the wireless content source 102 follows an AVRCP with meta data 108 function to receive and implement the standard AVRCP control commands 150 and meta data commands as also described in greater detail herein below.

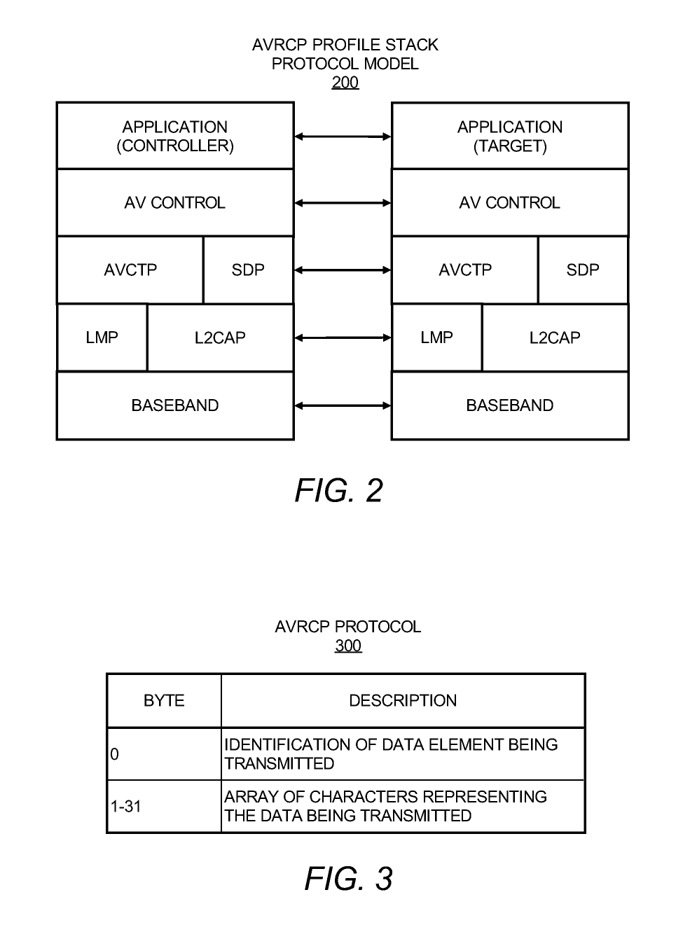

With reference now to FIG. 2, there is shown a schematic illustration of the AVRCP profile stack protocol model 200. As shown in FIG. 2, a baseband, a Link Management Protocol (hereinafter “LMP”) and a Logical Link Control and Adaptation Protocol (hereinafter “L2CAP”) are Bluetooth® protocols equivalent to layers 1 and 2 of the Open Systems Interconnect (hereinafter “OSI”). The Audio/Visual Control Transport Protocol (hereinafter “AVCTP”) defines the procedures and messages to be exchanged for controlling audio/visual devices, such as the wireless content source 102 and the output device 130. The SDP specifies the Bluetooth® service discovery protocol and the AV Control is the entity for controlling the AV device signaling, which is based on an AV/C command.

In the wireless communication system 100, the wireless content source 102 has the AVRCP target function and the sink device 120 has the AVRCP controller function. More particularly, the sink device 120 has the controller function for transmitting the AVRCP control commands 150 to the wireless content source 102.

An L2CAP connection may be established by either the wireless content source 102 or the sink device 120. Establishment of the L2CAP connection may be initiated by an internal event generated by a user, for instance, such as by turning the power on for one or both the wireless content source 102 and the sink device 120.

According to an embodiment of the invention, the AVRCP meta data 152 may be sent between the wireless content source 102 and the sink device 120 through AVRCP vendor-specific pass-through packets. More particularly, the first byte of the AVRCP header body (operation_data), which identifies the AVRCP vendor-specific pass-through packets as vendor-specific data, is used to identify the kind of data element contained in the AVRCP vendor-specific pass-through packets. In addition, the remainder of the AVRCP header body comprises the data itself, which is assumed to have a length equal to operation_data_length-1. Thus, for instance, the AVRCP header may have the protocol depicted in the AVRCP Protocol table 300 shown in FIG. 3.

As shown in FIG. 3, the first byte (0) may identify the data element being transmitted. In addition, the remaining bytes (1-31), for a 32 total byte header, may be composed of an array of characters that represent the data being transmitted through an AVRCP vendor-specific pass-through packet.

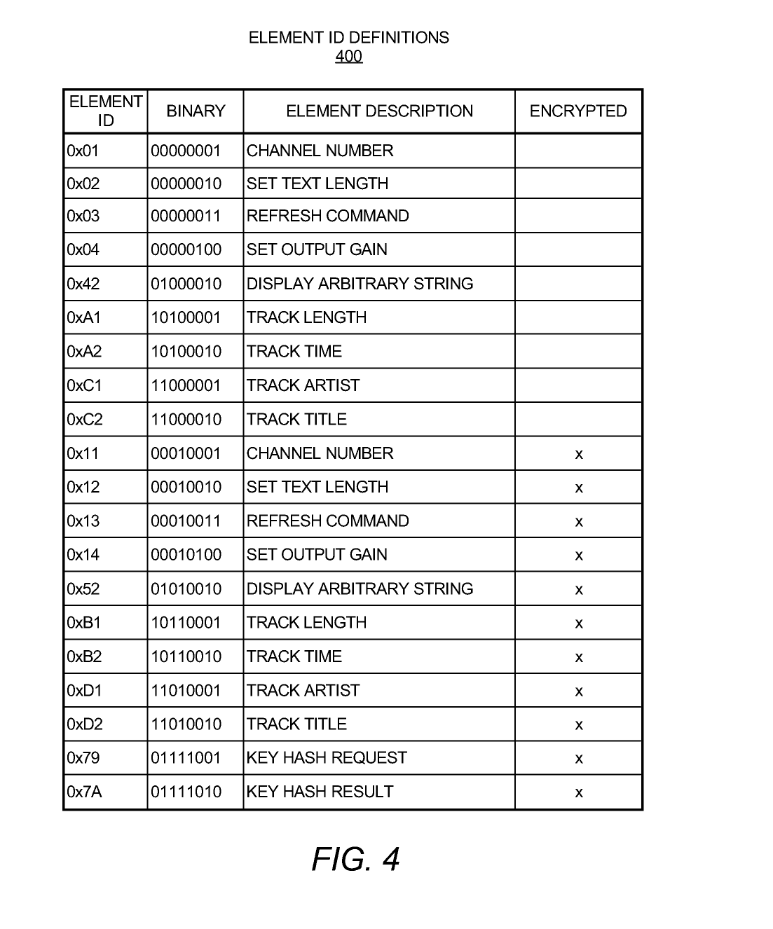

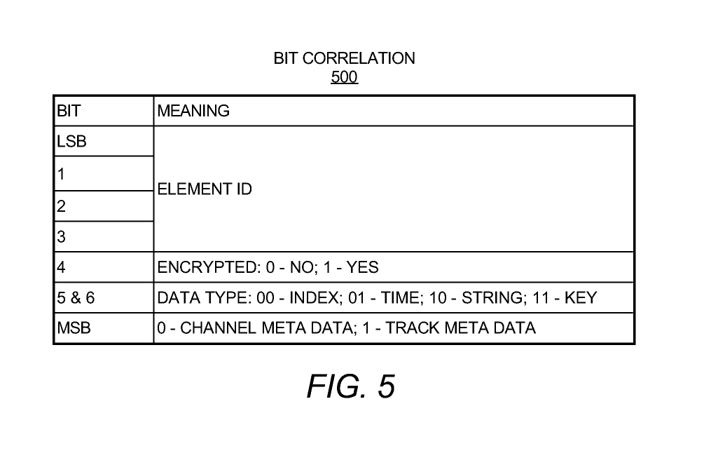

An example of a manner in which the data element identifications (Element ID's) may be defined is depicted in the Element ID Definitions table 400 shown in FIG. 4. As shown, the Element ID's may be defined in binary form and also by their element descriptions. In addition, the bits in the binary forms of the Element ID's and their meanings may be correlated as shown in the Bit Correlation table 500 shown in FIG. 5. More particularly, for instance, FIG. 5 shows that the least significant bit (LSB) to bit 3 is used to define the Element ID, bit 4 is used to define whether the Element ID is encrypted, bits 6 and 7 are used to define the data type, and the most significant bit (MSB) is used to define whether the Element ID pertains to a channel meta data or to a track meta data.

According to an embodiment, the body data of the AVRCP vendor-specific pass-through packet, excluding the Element ID byte, may be encrypted. The encryption may be performed through, for instance, XORing the body data with a mutually hard-coded 128-bit (16 byte) private key. An example of a suitable mutually hard-coded 128-bit private key is as follows: c4 bf 95 64 02 21 bf 8d e1 68 d4 94 0e 13 9e 94.

In the example shown in FIG. 5, when the body data is encrypted, bit 4 of the Element ID is set to 1.

It should be understood to those of ordinary skill in the art that the examples shown in FIGS. 3-5 are for illustrative purposes. As such, it should also be understood that various elements depicted in FIGS. 3-5 may be changed, omitted, or rearranged without departing from a scope of the invention.

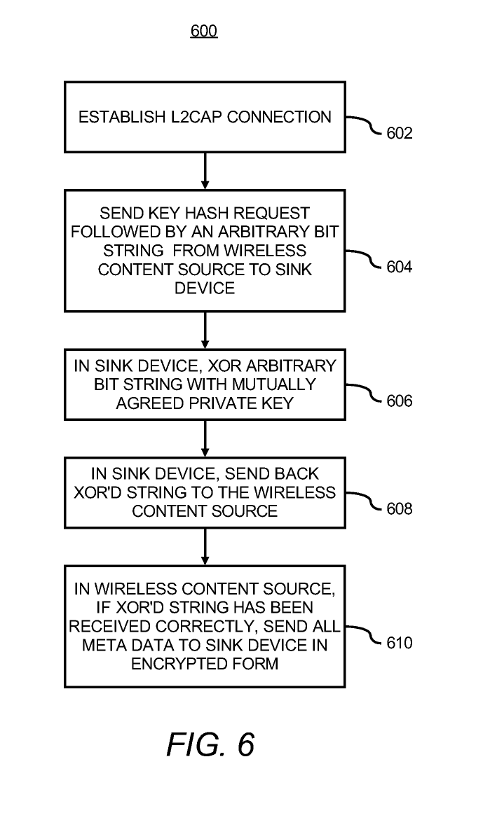

Turning now to FIG. 6, there is shown a method 600 for communicating meta data between components of a wireless communication system 100. It is to be understood that the following description of the method 600 is but one manner of a variety of different manners in which examples of the wireless communication system 100 depicted in FIG. 1 may be practiced. It should also be apparent to those of ordinary skill in the art that the method 600 represents a generalized illustration and that other steps may be added or existing steps may be removed, modified or rearranged without departing from a scope of the method 600.

The method 600 is described with respect to FIG. 1 by way of example and not of limitation. It will thus be apparent to one of ordinary skill in the art, that the method 600 may be performed with systems other than the wireless communication system 100 depicted in FIG. 1. In addition, the method 600 depicts a manner in which encrypted meta data may be communicated between the wireless content source 102 and the sink device 120. It should, however, be understood that the meta data may be communicated through use of vendor-specific pass-through packets of an AVRCP header as described above with respect to FIGS. 3-5 regardless of whether the meta data is encrypted.

At step 602, an L2CAP connection may be established between the wireless content source 102 and the sink device 120. An L2CAP connection may be established by either the wireless content source 102 or the sink device 120. The L2CAP connection may be initiated, for instance, by a user or it may be automatically initiated by the wireless content source 102 or the sink device 120.

At step 604, the wireless content source 102 may send a key hash request followed by an arbitrary bit string to the sink device 120. The arbitrary bit string may comprise, for instance, an arbitrary 128-bit string. In addition, the key hash request may, for instance, be sent as 0x79, as shown in FIG. 4.

The sink device 120 may XOR the arbitrary bit string with a mutually agreed private key, as indicated at step 606. In addition, the sink device 120 may send the XOR'd arbitrary bit string back to the wireless content source 102 followed by the XOR'd result. For instance, the XOR'd string may be sent back as 0x7A, as also shown in FIG. 4.

The wireless content source 102 may determine whether the XOR'd bit string has been received correctly at step 610. In addition, if the XOR'd bit string has been received correctly, the wireless content source 102 may send all of the meta data to the sink device 120 in encrypted form.

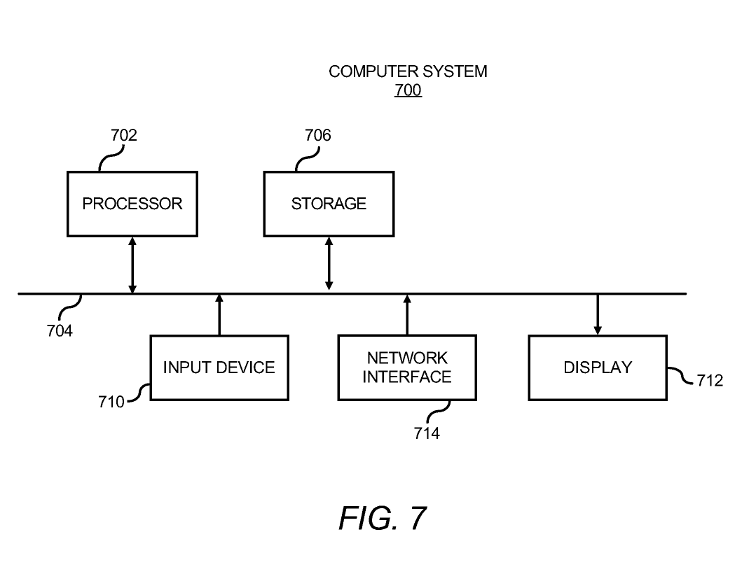

FIG. 7 illustrates a block diagram of a computer system 700 which may be used as a hardware platform for either or both of the wireless content source 102 and the sink device 120 depicted in FIG. 1. The computer system 700 is a simplified block diagram, and either or both of the wireless content source 102 and the sink device 120 may include many more elements not shown or may not include all of the elements shown in FIG. 5.

The computer system 700 may include a processor 702, which provides a platform for executing software. The computer system 700 also includes a storage 706, which may include Random Access Memory (RAM) where software is resident during runtime. The storage 706 may also include one or more other types of memory such as ROM (read only memory), EPROM (erasable, programmable ROM), EEPROM (electrically erasable, programmable ROM) and data storage, such as hard disks, etc., may be used. For example, the storage 706 may include one or more hard disk drives and a removable storage drive, such as a floppy or flash memory.

A user may interface with the computer system 700 through an input device 710, such as, a keyboard, buttons, a mouse, a stylus, and the like. A display 712 and a network interface 714 may also be included. In addition, the processor 702 may communicate with one or more of the components depicted in FIG. 7 over a bus 704.

One or more of the steps of the method 700 and other steps described herein and software described herein may be implemented as software embedded or stored on a computer readable medium, such as the storage 706, and executed by the processor 702. The steps may be embodied by a computer program, which may exist in a variety of forms both active and inactive. For example, there may exist as software program(s) comprised of program instructions in source code, object code, executable code or other formats for performing some of the steps when executed. Any of the above may be stored on a computer readable medium, which include storage devices and signals, in compressed or uncompressed form. Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that those functions enumerated herein may be performed by any electronic device capable of executing the above-described functions.

Through implementation of the systems and methods disclosed herein, information pertaining to the content being wirelessly transmitted between a source device and a sink device may be communicated in a relatively simple manner over existing communication protocols. As such, information pertaining to, for instance, song title, song artist, song category, movie title, etc., may be transmitted from the source device to the sink device, such that this information may be displayed to a user on an output device, through the existing communication protocols.

While the embodiments have been described with reference to examples, those skilled in the art will be able to make various modifications to the described embodiments without departing from the true spirit and scope. The terms and descriptions used herein are set forth by way of illustration only and are not meant as limitations. In particular, although the methods have been described by examples, steps of the methods may be performed in different orders than illustrated or simultaneously. Those skilled in the art will recognize that these and other variations are possible within the spirit and scope as defined in the following claims and their equivalents.

What is claimed is:

1. A method for communicating meta data comprising the steps of:
utilizing vendor-specific pass-through packets of an Audio/Visual Remote Control Profile (AVRCP) header to communicate the meta data from a wireless content source to a sink device.

2. The method according to claim 1, wherein utilizing vendor-specific pass-through packets further comprises utilizing vendor-specific pass-through packets defined in the AVRCP of a relatively short distance wireless communication technique to communicate meta data from the wireless content source to the sink device.

3. The method according to claim 2, wherein utilizing vendor-specific pass-through packets further comprises utilizing a first byte of the AVRCP header to identify the type of data element being communicated from the wireless content source to the sink device; and
utilizing the remaining bytes of the AVRCP header to include an array of characters representing the data being communicated from the wireless content source to the sink device.

4. The method according to claim 3, further comprising:
assigning element identifications and binary representations of a plurality of data element types.

5. The method according to claim 4, further comprising:
assigning a plurality of bits to the element identifications of the data element being communicated;
assigning a bit to the encryption status of the data element;
assigning at least one bit to the data element type; and
assigning at least one bit to the type of meta data being communicated in the data element.

6. The method according to claim 1, further comprising:
establishing a Logical Link Control and Adaptation Protocol (L2CAP) connection between the wireless content source and the sink device;
determining whether the sink device has the correct private key; and
communicating the meta data in response to a determination that the sink device has the correct private key.

7. The method according to claim 6, wherein determining whether the sink device has the correct private key further comprises:
sending a hash request followed by an arbitrary bit string from the wireless content source to the sink device;
in the sink device, XORing the arbitrary bit string with a mutually agreed private key and sending back the XOR'd arbitrary bit string to the wireless content source; and
in the wireless content source, determining whether the XOR'd arbitrary bit string is received correctly.

8. The method according to claim 7, wherein communicating the meta data in response to a determination that the sink device has the correct private key further comprises sending the meta data in encrypted form in response to the XOR'd arbitrary bit string being received correctly.

9. The method according to claim 1, further comprising:
communicating at least one of a song artist, song title, song category, and song time from the wireless content source to the sink device through use of the vendor-specific pass-through packets.

10. A wireless device for communicating meta data with a sink device, said wireless device comprising:
a protocol stack configured to enable wireless communications with at least one sink device having a compatible protocol stack; and
wherein a portion of the protocol stack contains a data structure having multiple bytes of data for remotely controlling at least one of an audio and a video functionality, and wherein the first byte of data in the data structure includes meta data identifying content being at least one of transmitted from and received by the wireless device.

11. The wireless device according to claim 10, wherein the protocol stack comprises an Audio/Visual Remote Control Profile (AVRCP) of a relatively short range communication technique.

12. The wireless device according to claim 11, wherein the data structure comprises an AVRCP header.

13. The wireless device according to claim 10, wherein the data structure is assigned binary representations of the meta data identifying the content, and wherein a plurality of bits are assigned to represent element identifications of the content, a bit is assigned to the encryption status of the content, at least one bit is assigned to the content type, and at least one bit is assigned to the type of meta data identifying the content.

14. The wireless device according to claim 10, wherein the data structure is configured to be encrypted.

15. A sink device for wirelessly communicating with a source device, said sink device comprising:
a protocol stack configured to enable wireless communications with the source device;
wherein a portion of the protocol stack is configured to receive a data structure having multiple bytes of data for remotely controlling at least one of an audio and a video functionality, and wherein the first byte of data in the data structure includes meta data identifying content being at least one of transmitted from and received by the sink device.

16. The sink device according to claim 15, said sink device being configured to communicate with an output device, said sink device further comprising:
an adapter configured to facilitate transfer of the data structure including the meta data between the source device and the output device.

17. A computer-readable data structure, contained on a computer readable medium, for communicating meta data, the data structure comprising:
a plurality of profiles, at least one of the profiles including a data profile for remote control of at least one of an audio and a video functionality, the at least one data profile for remote control including a field of multiple bytes of data, wherein the first byte of the field includes meta data identifying content being transmitted in accordance with the at least one data profile.

18. The data structure according to claim 17, wherein the at least one data profile comprises an Audio/Visual Remote Control Profile (AVRCP) of a relatively short range communication technique.

19. The data structure according to claim 18, wherein the field of multiple bytes of data forms part of an AVRCP header.

20. The data structure according to claim 17, wherein the first byte of the multiple bytes of data is assigned binary representations of the meta data identifying the content, and wherein a plurality of bits are assigned to represent element identifications of the content, a bit is assigned to the encryption status of the content, at least one bit is assigned to the content type, and at least one bit is assigned to the type of meta data identifying the content.

21. A computer readable storage medium on which is embedded one or more computer programs, said one or more computer programs implementing a method for communicating meta data between a wireless content source and a sink device, said one or more computer programs comprising a set of instructions for:
utilizing vendor-specific pass-through packets of an Audio/Visual Remote Control Profile (AVRCP) header to communicate the meta data between the wireless content source and the sink device.

22. The computer readable storage medium according to claim 21, the set of instructions further comprising:
utilizing a first byte of the AVRCP header to identify the type of data element being communicated between the wireless content source and the sink device; and
utilizing the remaining bytes of the AVRCP header to include an array of characters representing the data being communicated between the wireless content source and the sink device.

23. The computer readable storage medium according to claim 22, the set of instructions further comprising:
assigning element identifications and binary representations of a plurality of data element types.
assigning a plurality of bits to the element identifications of the data element being communicated;
assigning a bit to the encryption status of the data element;
assigning at least one bit to the data element type; and
assigning at least one bit to the type of meta data being communicated in the data element.
